(19) United States
(12) Patent Application Publication
(10) Pub. No.: US 2026/0118567 A1
(43) Pub. Date: Apr. 30, 2026

(54) Reflective Polarizer and Lens Assembly Including Same

(71) Applicant: 3M INNOVATIVE PROPERTIES COMPANY, St. Paul, MN (US)

(72) Inventors: Yifan Xu, Woodbury, MN (US); Adam D. Haag, Woodbury, MN (US); Lin Zhao, Woodbury, MN (US); Robert D. Taylor, Stacy, MN (US); David J.W. Aastuen, Shoreview, MN (US); Ryan J. Eismin, St. Paul, MN (US); Justin M. Foley, Minneapolis, MN (US); Mark B. O'Neill, Stillwater, MN (US); Matthew C. Dachel, Baldwin, WI (US); Jacob W. Jaeschke, Cottage Grove, MN (US); Kayla A. McGrath, Cottage Grove, MN (US); Susan L. Kent, Shorewood, MN (US)

(21) Appl. No.: 19/157,546

(22) PCT Filed: Feb. 19, 2024
(86) PCT No.: PCT/IB2024/051574

§ 371 Date: Aug. 18, 2025

Related U.S. Application Data
(60) Provisional application No. 63/486,726, filed on Feb. 24, 2023.

(51) Int. Cl. G02B 5/30

(52) U.S. Cl. CPC G02B 5/305; G02B 5/3066

(57) ABSTRACT

A biaxially stretched reflective polarizer includes a plurality of biaxially stretched polymeric layers numbering at least 10 in total where each of the polymeric layers has an average thickness of less than about 500 nm. The reflective polarizer is stretched along orthogonal first and second directions by respective S1 and S2 percentages where S2≥2% and S2/S1≤10, such that for at least one location on the reflective polarizer, a substantially normally incident light at the at least one location, and for a visible wavelength range extending from about 420 nm to about 680 nm, the plurality of polymeric layers has: an average reflectance of greater than about 60% when the incident light is polarized along the first direction; and an average transmittance of greater than about 60% and an average reflectance of less than about 1% when the incident light is polarized along the second direction.

### TECHNICAL FIELD

The present description relates generally to reflective polarizers that can be stretched and/or curved.

### BACKGROUND

A reflective polarizer can include a plurality of alternating first and second polymeric layers.

### SUMMARY

In some aspects, the present description provides a biaxially stretched reflective polarizer including a plurality of biaxially stretched polymeric layers numbering at least 10 in total where each of the biaxially stretched polymeric layers can have an average thickness of less than about 500 nm. The biaxially stretched reflective polarizer is stretched along in-plane mutually orthogonal first and second directions by respective S1 and S2 percentages where S2≥2% and S2/S1≤10, such that for at least one location on the biaxially stretched reflective polarizer, a substantially normally incident light at the at least one location, and a visible wavelength range extending from about 420 nm to about 680 nm, the plurality of biaxially stretched polymeric layers has: an average reflectance of greater than about 60% when the incident light is polarized along the first direction; and an average transmittance of greater than about 60% and an average reflectance of less than about 1% when the incident light is polarized along the second direction.

In some aspects, the present description provides a curved reflective polarizer including a plurality of curved polymeric layers numbering at least 10 in total where each of the curved polymeric layers has an average thickness of less than about 500 nm. The curved reflective polarizer has first and second radii of curvature along mutually orthogonal first and second directions where each of the first and second radii of curvature can be greater than about 1 mm and less than about 500 mm, such that for at least one location on the curved reflective polarizer, a substantially normally incident light at the at least one location, and a visible wavelength range extending from about 420 nm to about 680 nm, the plurality of curved polymeric layers has: an average reflectance of greater than about 60% when the incident light is polarized along the first direction; and an average transmittance of greater than about 60% and an average reflectance of less than about 1% when the incident light is polarized along the second direction.

In some aspects, the present description provides a curved reflective polarizer including a plurality of curved polymeric layers numbering at least 10 in total where each of the curved polymeric layers has an average thickness of less than about 500 nm. The curved reflective polarizer has first and second radii of curvature along mutually orthogonal first and second directions where each of the first and second radii of curvature can be greater than about 1 mm and less than about 500 mm, such that for at least one location on the curved reflective polarizer, a substantially normally incident light at the at least one location, a blue wavelength range extending from about 420 nm to about 480 nm, a green wavelength range extending from about 490 nm to about 560 nm, and a red wavelength range extending from about 590 nm to about 670 nm, the plurality of curved polymeric layers has average reflectances R2b, R2g and R2r in the respective blue, green and red wavelength regions when the incident light is polarized along the second direction, where 2.2%≥R2b−R2g≥0.1% and 2.5%≥R2b−R2r≥−0.1%.

In some aspects, the present description provides a method including providing a reflective polarizer substantially uniaxially oriented along a first direction and including a plurality of polymeric layers numbering at least 10 in total where each of the polymeric layers has an average thickness of less than about 500 nm, such that for a substantially normally incident light, and for a visible wavelength range extending from about 420 nm to about 680 nm, the plurality of polymeric layers of the substantially uniaxially oriented reflective polarizer has an average reflectance of greater than about 60% when the incident light is polarized along the first direction; and an average transmittance of greater than about 60% and an average reflectance Rp1 when the incident light is polarized along a second direction orthogonal to the first direction. The method includes biaxially stretching the reflective polarizer along the first and second directions by respective S1 and S2 percentages, where S2≥2% and S2/S1≤10, such that for at least one location on the biaxially stretched reflective polarizer, for a substantially normally incident light at the at least one location, and for the visible wavelength range, the plurality of polymeric layers of the biaxially stretched reflective polarizer has an average reflectance Rp2 of less than about 1% when the incident light at the at least one location is polarized along the second direction. Rp2 may be no greater than about 3 times Rp1.

In some aspects, the present description provides a method including providing a reflective polarizer substantially uniaxially oriented along a first direction and including a plurality of polymeric layers numbering at least 10 in total where each of the polymeric layers having an average thickness of less than about 500 nm, such that for a substantially normally incident light, and for a visible wavelength range extending from about 420 nm to about 680 nm, the plurality of polymeric layers of the substantially uniaxially oriented reflective polarizer has an average reflectance of greater than about 60% when the incident light is polarized along the first direction; and an average transmittance of greater than about 60% and an average reflectance Rp1 when the incident light is polarized along a second direction orthogonal to the first direction. The method includes forming the reflective polarizer into a curved reflective polarizer, such that the curved reflective polarizer has first and second radii of curvature along mutually orthogonal first and second directions where each of the first and second radii of curvature can be greater than about 1 mm and less than about 500 mm, such that for at least one location on the curved reflective polarizer, for a substantially normally incident light at the at least one location, and for the visible wavelength range, the plurality of polymeric layers of the curved reflective polarizer has an average reflectance Rp2 of less than about 1% when the incident light at the at least one location is polarized along the second direction. Rp2 is no greater than about 3 times Rp1.

These and other aspects will be apparent from the following detailed description. In no event, however, should this brief summary be construed to limit the claimable subject matter.

### BRIEF DESCRIPTION OF THE DRAWINGS

FIG. 1 is a schematic cross-sectional view of a reflective polarizer, according to some embodiments.

FIG. 2 is a plot of reflectance and transmittance versus wavelength of a plurality of layers of a reflective polarizer for substantially normally incident light, according to some embodiments.

FIG. 3 is scatter plot showing average reflectance of pluralities of layers of reflective polarizers for substantially normally incident light for a pass polarization state and for various stretching conditions, according to some embodiments.

FIG. 4A is a plot of difference in average pass state reflectances in blue and green wavelength ranges as a function of stretch ratio for substantially normally incident light, according to some embodiments.

FIG. 4B shows an expanded portion of the plot of FIG. 4A.

FIG. 5A is a plot of difference in average pass state reflectances in blue and red wavelength ranges as a function of stretch ratio for substantially normally incident light, according to some embodiments.

FIG. 5B shows an expanded portion of the plot of FIG. 5A.

FIG. 6 is a scatter plot of average transmittance of reflective polarizers for substantially normally incident light for a block polarization state and for various stretching conditions, according to some embodiments.

FIG. 7 is a schematic cross-sectional view of a curved reflective polarizer, according to some embodiments.

FIG. 8 is a schematic perspective view of a curved reflective polarizer, according to some embodiments.

FIG. 9 is a schematic perspective view of a lens assembly, according to some embodiments.

### DETAILED DESCRIPTION

In the following description, reference is made to the accompanying drawings that form a part hereof and in which various embodiments are shown by way of illustration. The drawings are not necessarily to scale. It is to be understood that other embodiments are contemplated and may be made without departing from the scope or spirit of the present description. The following detailed description, therefore, is not to be taken in a limiting sense.

In various optical system applications, such as head-mounted display applications, for example, it is often desired for a reflective polarizer to be curved (e.g., via thermoforming) so that it can conform to a curved surface of an optical lens, for example. Optical systems utilizing curved reflective polarizers are described in U.S. Pat. No. 9,835,777 (Ouderkirk et al.); U.S. Pat. No. 10,564,427 (Ouderkirk et al.); and U.S. Pat. No. 11,262,565 (Etter et al.), for example. The reflective polarizer is typically curved around two orthogonal axes to form a compound curved shape. Thermoforming the reflective polarizer into such shapes includes stretching the reflective polarizer. Here, (e.g., biaxially) stretching a reflective polarizer refers to stretching a previously made reflective polarizer. The previously made reflective polarizer may have been made by (e.g., uniaxially) stretching a plurality of polymeric layers. It has been found that when reflective polarizers are formed (e.g., thermoformed) and stretched into desired curved shapes using conventional forming processes, that the stretching of the reflective polarizer can result in an undesired increase in the pass state reflectance of the reflective polarizer. Without intending to be limited by theory, it is believed that this increase in pass state reflectance results from a shift in refractive indices of the layers of the reflective polarizer during the conventional forming process which may involve at least locally stretching the film substantially more in one in-plane direction than in an orthogonal in-plane direction. This asymmetric stretching can be due to intentionally stretching the film primarily along one in-plane direction or can be due to different moduli of the reflective polarizer in the different in-plane directions resulting in larger stretching in the direction of lower modulus, for example.

According to some embodiments of the present description, it has been found that when the forming process is modified to provide similar strains along orthogon in-plane directions (e.g., block and pass directions), that any increase in the pass state reflectance when forming can be substantially reduced compared to conventional forming processes. It has been found, according to some embodiments, that providing similar strains can be obtained by controlling stretch ratios along block and pass directions S1 and S2, respectively, such that S2/S1 is no more than 10, or 9, or 8, or 7, or 6, or 5, or 4, for example. To keep the strains similar while allowing a desired degree of stretchability/formability, S2/S1 can be at least 0.4, 0.5, 0.6, 0.7, 0.8, 0.9, or 1, for example. Further, it has been found, according to some embodiments, that differences between average pass state reflectances in blue (R2b), red (R2r), and green (R2g) wavelength ranges can be approximately preserved, or increased by desired or acceptable amounts, by the stretching/forming processes described herein. For example, in some embodiments, 2.2%≥R2b−R2g≥0.1% and 2.5%≥R2b−R2r≥−0.1%, before and after stretching/shaping the reflective polarizer. In contrast, conventional processes can result in the differences increasing such that R2b−R2g is undesirably greater than 2.2% and R2b−R2r is undesirably greater than 2.5%, for example.

A reflective polarizer can be a multilayer optical film. As is known in the art, multilayer optical films including alternating polymeric layers can be used to provide desired reflection and transmission in desired wavelength ranges and polarization states by suitable selection of layer thicknesses and refractive index differences. Multilayer optical films and methods of making multilayer optical films are described in U.S. Pat. No. 5,882,774 (Jonza et al.); U.S. Pat. No. 6,783,349 (Neavin et al.); U.S. Pat. No. 6,949,212 (Merrill et al.); U.S. Pat. No. 6,967,778 (Wheatley et al.); U.S. Pat. No. 9,162,406 (Neavin et al.); and U.S. Pat. No. 11,493,677 (Haag et al.), for example.

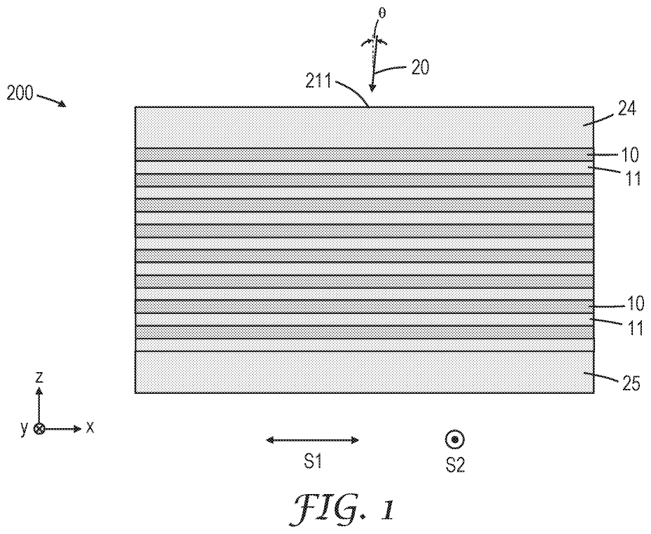

FIG. 1 is a schematic cross-sectional view of a reflective polarizer 200, according to some embodiments. The reflective polarizer 200 includes a plurality of polymeric layers 10, 11 numbering at least 10, or 25, or 50, or 100, or 200, or 300, or 400, or 500, or 600, or 700 in total. The plurality of polymeric layers 10, 11 can number up to 3000, or 2000, or 1500, or 1200, for example. Each of the polymeric layers 10, 11 has an average thickness of less than about 500, or 400, or 300, or 200 nm. Each of the polymeric layers 10, 11 can have an average thickness greater than about 10, or 20, or 30, or 40 or 50 nm, for example. The plurality of polymeric layers 10, 11 may be arranged as a plurality of alternating first and second polymeric layers 10 and 11 where the first and second polymeric layers 10 and 11 have different compositions. In some embodiments, the plurality of polymeric layers 10, 11 is disposed between first and second skin layers 24 and 25. In some embodiments, each of the first and second skin layers 24 and 25 has an average thickness of greater than about 500, 600, 700, 800, 900, 1000, 1250, 1500, 1750, or 2000 nm. The average thickness of each of the skin layers can be up to about 150, 100, 50, 30, 20, or 10 microns, for example. In some embodiments, the skin layers 24 and 25 may have a same composition as that of layers 10 or layers 11, for example.

Suitable materials for the various layers of the reflective polarizer 200 include polyethylene naphthalate (PEN), polyethylene terephthalate (PET), polycarbonate, copolyesters such as glycol-modified PET, and blends or copolymers thereof. Other suitable materials are described in the multilayer optical film references provided elsewhere herein.

The reflective polarizer 200 can be a biaxially stretched reflective polarizer and the plurality of polymeric layers 10, 11 can be a plurality of biaxially stretched polymeric layers. The biaxially stretched reflective polarizer has been biaxially stretched after the reflective polarizer was initially made. The initial process of making the reflective polarizer may have involved other stretching processes. For example, the reflective polarizer 200 can be initially made by substantially uniaxially orienting a plurality of extruded polymeric layers and then the resulting reflective polarizer can be subsequently biaxially stretched. The subsequent (biaxial) stretching step may be applied in order to shape the reflective polarizer into a curved shape, for example. The biaxial stretching of the reflective polarizer generally alters the molecular orientation of the initially uniaxially oriented layers which may affect optical properties and/or mechanical properties such as modulus along orthogonal directions, for example. The biaxially stretched reflective polarizer can be stretched along in-plane mutually orthogonal first and second directions (e.g., x- and y-directions, respectively, referring to the illustrated x-y-z coordinate system) by respective S1 and S2 percentages which are schematically indicated in FIG. 1. The in-plane directions can be directions in a tangent plane when the reflective polarizer is curved, for example. In some embodiments, S2≥2%, or 3%, or 4%, or 5%, or 6%, or 7%, or 8%. In some embodiments, S2≤20%, or 18%, or 16%, or 14%, or 12%, or 10%, for example. For example, in some embodiments, 14%≥S2≥3%, or 12%≥S2≥4%, or 10%≥S2≥5%. In some embodiments, S2/S1≤10, or 9, or 8, or 7, or 6, or 5, or 4, or 3.5, or 3. In some embodiments, S2/S1≥0.4, 0.5, 0.6, 0.7, 0.8, 0.9, 1, 1.1, or 1.2, for example. For example, in some embodiments, 0.5≤S2/S1≤8, or 0.8≤S2/S1≤6, or 1≤S2/S1≤5. In some embodiments, S1≥0.1%, or 0.2%, or 0.4%, or 0.6%, or 8%, or 1%, or 1.2% for example. In some embodiments, 14%≥S2>S1≥0.6%, for example. The biaxial stretching of the reflective polarizer generally alters the molecular orientation of the initially uniaxially oriented layers which may affect optical properties and/or mechanical properties such as modulus along orthogonal directions, for example. Different S1 and S2 percentages generally results in different alterations of the molecular orientation of the initially uniaxially oriented layers.

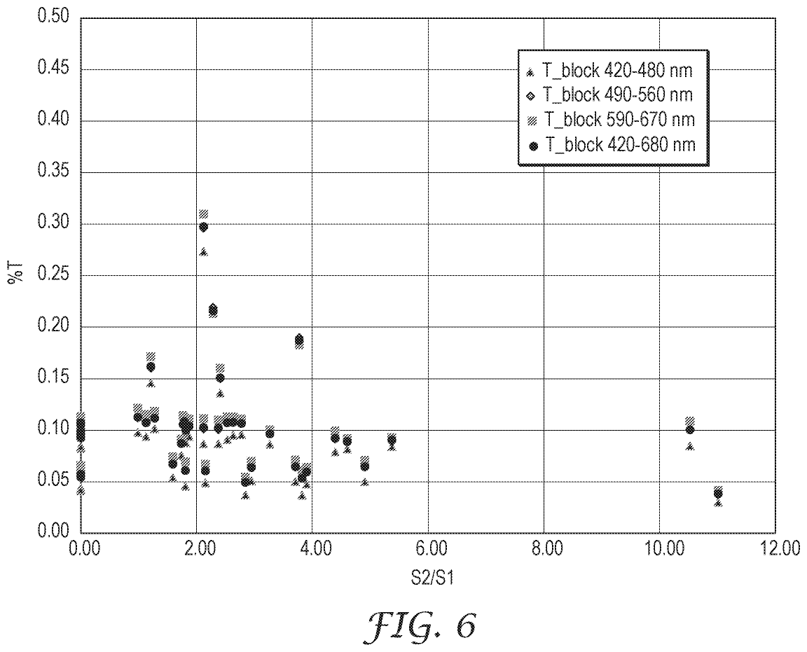

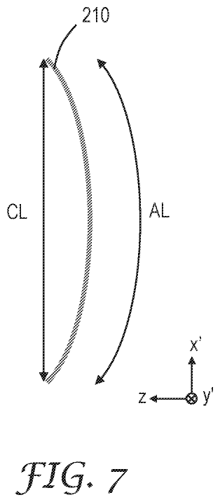

The biaxial stretching can be applied in a process of thermoforming the reflective polarizer into a curved shape. Useful methods of thermoforming a reflective polarizer are described in U.S. Pat. No. 11,543,572 (Jennings et al.) and U.S. Pat. No. 11,358,355 (Jennings et al.), for example. The stretch ratio S2/S1 can be controlled, for example, by using clamps or other securing means around the edges of a reflective polarizer film when the film is thermoformed to control tensions in the film along the first and second directions during the thermoforming process. For example, the process of FIG. 6 of U.S. Pat. No. 11,358,355 (Jennings et al.) can be modified to provide the tensions needed to result in the desired stretch ratio S2/S1 by modifying the tensions generated by the clamps along the x- and y-directions. The reflective polarizer 200 can be a curved reflective polarizer (see, e.g., FIGS. 7-9) and the plurality of polymeric layers 10, 11 can be a plurality of curved polymeric layers. For example, tensions can be applied along orthogonal directions to control S1 and S2 while the film is stretched against a curved surface. The curved surface can be a surface of the optical lens, for example, and the film can become bonded to the optical lens as a result of the stretching process (e.g., at a temperature greater than a glass transition temperature of at least one layer the reflective polarizer). Alternatively, the curved surface can be a (e.g., release treated) surface of a (e.g., heated) mold and the reflective polarizer may be released from the mold surface after being curved into a desired shape.

It has been found that starting with a reflective polarizer having a plurality of layers 10, 11 with a low pass state reflection can result in a biaxially stretched and/or curved reflective polarizer with a low pass state reflection when the reflective polarizer is stretched with the stretch ratio in these ranges. In contrast, conventional forming processes can result in a substantially increased pass state reflectance. The low pass state reflection of the starting reflective polarizer can be achieved by closely matching refractive indices of the first and second layers 10 and 11 along the second (pass) direction. For example, the first layers 10 can be birefringent layers, the second layers 11 can be substantially optically isotropic layers, and the refractive index of the second layers 11 can be matched for at least one wavelength in the visible wavelength range to the refractive index of the first layers 10 along the second direction by choosing a blend polymers or copolymers (e.g., an amorphous blend of polycarbonate and glycol-modified PET such as PCTg available from Eastman Chemical Company, Knoxville, TN) for the second layers 11 to achieve the index match. Suitable reflective polarizers that can be stretched/shaped as described herein and that have a plurality of layers 10, 11 with a low pass state reflection include those available from 3M Company (St. Paul, MN) under the tradename 3M Image Quality Polarizer Enhanced (IQP E).

In some embodiments, the thickness variation of the biaxially stretched and/or curved reflective polarizer is less than thickness variations of a reflective polarizer stretched and/or shaped in conventional thermoforming process, for example. In some embodiments, a maximum thickness variation over a largest optically active region of the reflective polarizer is less than about 25, or 20, or 15, or 10, or 8, or 6, or 5, or 4, or 3 or 2 percent. The largest active region of the reflective polarizer is generally the largest region of the reflective polarizer intended to be utilized when the reflective polarizer is incorporated in an optical system. The largest active region can comprise at least 60, 70, 80, 85, 90, or 95 percent of a total area of the reflective polarizer.

Optical properties (e.g., pass and/or block state reflectance and/or transmittance) of the biaxially stretched and/or curved reflective polarizer can be specified for at least one location 211 of the reflective polarizer. The at least one location 211 may be or include each location over at least 60, 70, 80, 85, 90, or 95 percent of a total area of the reflective polarizer. The at least one location 211 may be or include each location in the largest optically active region of the reflective polarizer, for example.

A substantially normally incident light 20 incident on the reflective polarizer 200 is schematically illustrated in FIG. 1. In some embodiments, an incident angle θ of the substantially normally incident light 20 is less than about 20, or 15, or 12, or 10, or 9, or 8, or 7, or 6, or 5, or 4, or 3, or 2, or 1 degrees. The incident angle θ can be about 8 degrees (e.g., to facilitate reflectance measurement), for example. The reflectance and transmittance of the reflective polarizer or of the plurality of layers 10, 11 can be determined as a function of wavelength for the incident light 20 and for a first polarization state (e.g., polarized along the x-axis referring to the illustrated x-y-z coordinate system) and for an orthogonal second polarization state (e.g., polarized along the y-axis). The reflectance and transmittance of the plurality of layers 10, 11 can be determined from the reflectance and transmittance of the reflective polarizer 200 by subtracting out Fresnel reflections from the outer surfaces of the reflective polarizer 200, as would be appreciated by those of ordinary skill in the art. The resulting reflectance and transmittance may be referred to as immersed or internal reflectance and immersed or internal transmittance, respectively. The reflectance and transmittance of the reflective polarizer 200 in air includes surface reflections at the outer surface of the skin layers and may be referred to external reflectance and external transmittance, respectively, of the reflective polarizer 200.

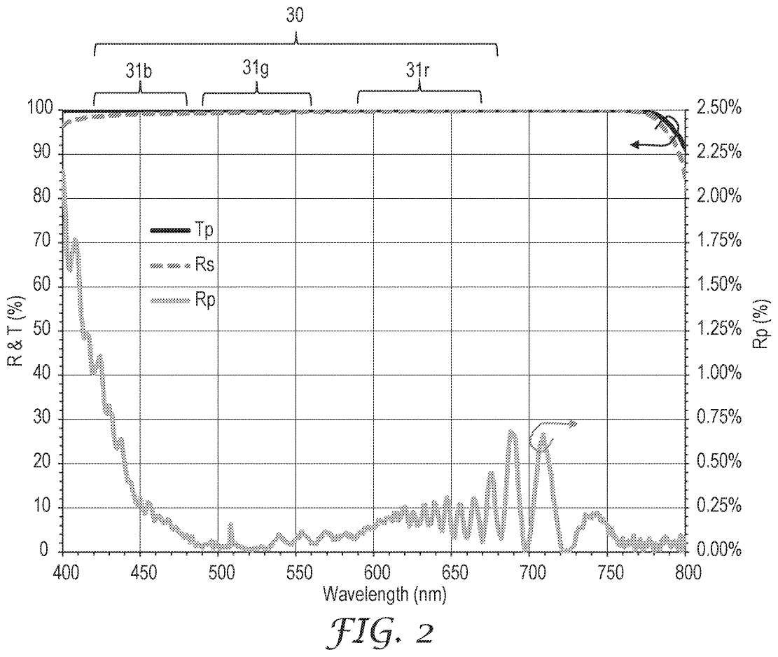

FIG. 2 is a plot of reflectance and transmittance versus wavelength of a plurality of layers 10, 11 of a reflective polarizer 200 for substantially normally incident light 20, according to some embodiments. The reflectance Rs and transmittance Tp for a first (e.g., x-axis, block) polarization state and a second (e.g., y-axis, pass) polarization state, respectively, are shown along the left axis while the reflectance Rp for the second polarization state is shown along the right axis.

In some embodiments, a reflective polarizer 200, 210 (see, e.g., FIGS. 1 and 7-9) is such that for at least one location (e.g., location 211) on the reflective polarizer, a substantially normally incident light 20 at the at least one location, and a visible wavelength range 30 extending from about 420 nm to about 680 nm, the plurality of (e.g., biaxially stretched and/or curved) polymeric layers 10, 11 has: an average reflectance of greater than about 60% when the incident light 20 is polarized along the first direction; and an average transmittance of greater than about 60% and an average reflectance Rp of less than about 1% (or 0.9%, or 0.8%, or 0.7%, or 0.6%, or 0.5%, or 0.4%, or 0.3%, or 0.2%) when the incident light 20 is polarized along the second direction. In some embodiments, the average reflectance when the incident light 20 is polarized along the first direction is greater than about 70%, or 80%, or 90%, or 95%. In some embodiments, the average transmittance when the incident light 20 is polarized along the second direction is greater than about 70%, or 80%, or 90%, or 95%. In some embodiments, the average reflectance when the incident light 20 is polarized along the second direction less than about 0.9%, or 0.8%, or 0.7%, or 0.6%, or 0.5%, or 0.4%, or 0.3%, or 0.2%. The reflectances and/or transmittances can be in any of these ranges before and/or after the reflective polarizer is biaxially stretched and/or curved.

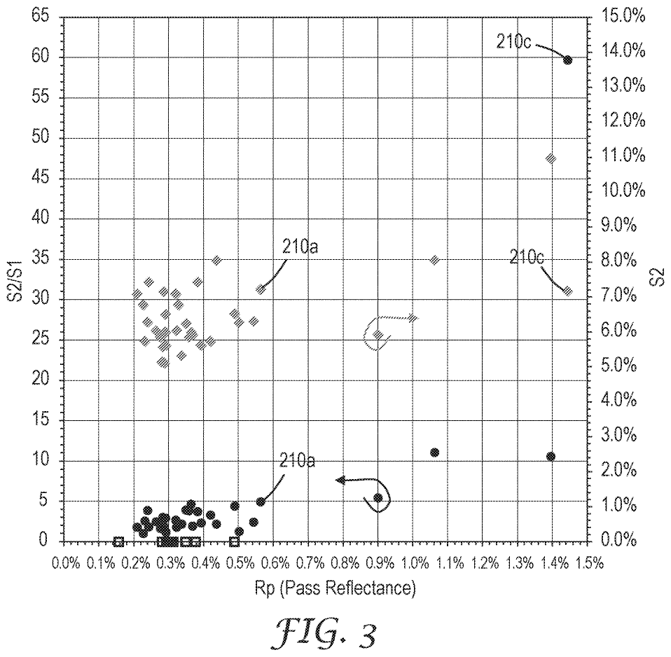

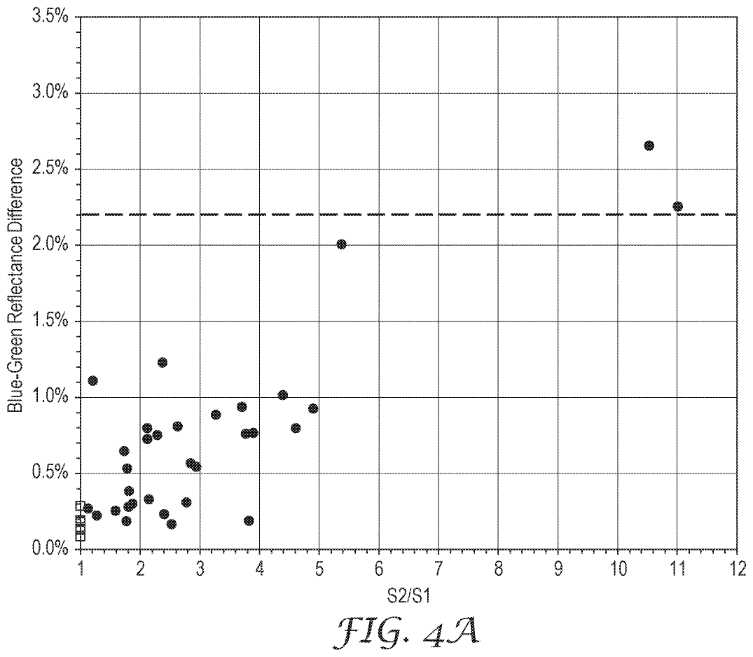

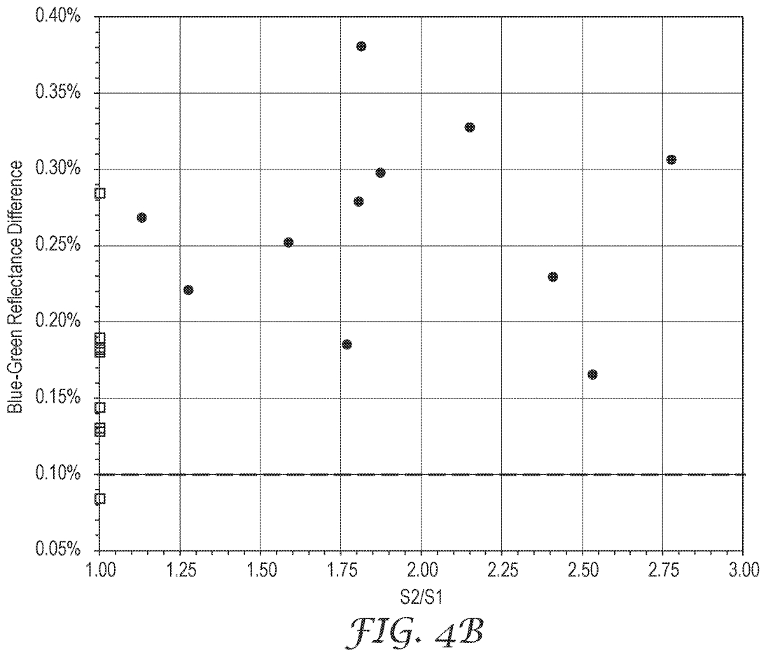

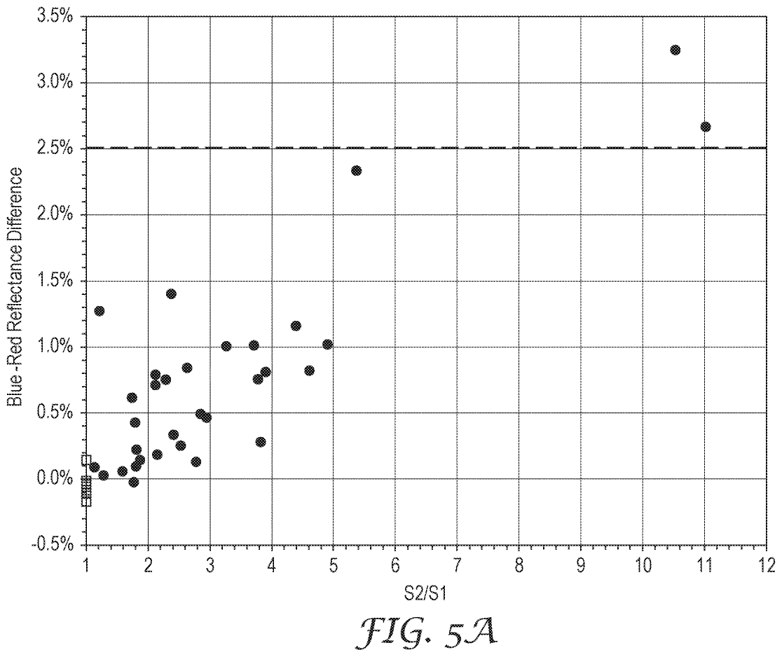

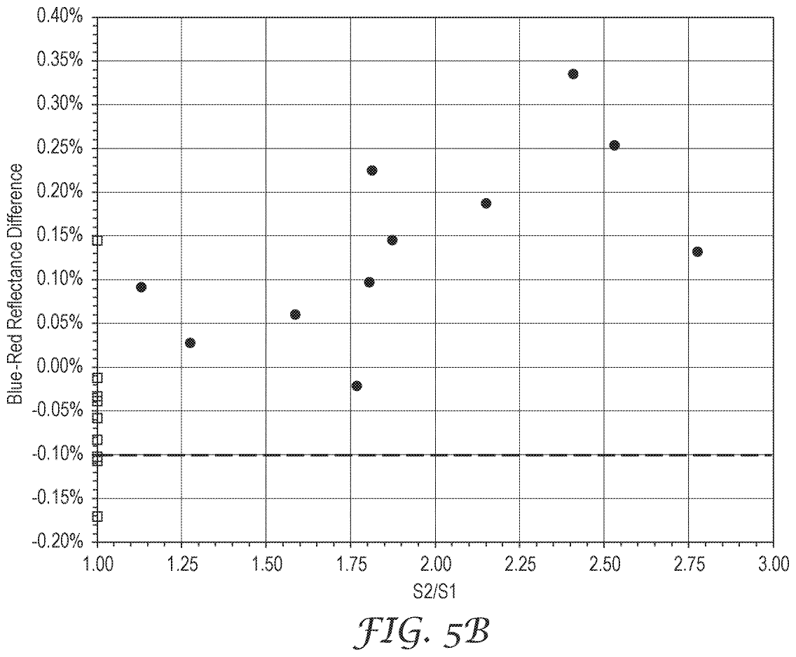

FIG. 3 is scatter plot showing average reflectance of a plurality of layers 10, 11 of a reflective polarizer 200, 210 for substantially normally incident light 20 polarized along the second direction for various stretching percentages S2 along the second direction and for various values of the ratio S2/S1, according to some embodiments. Each example reflective polarizer of FIG. 3 is represented by a solid circle defining the S2/S1 value and a solid diamond representing the S2 value. For example, a reflective polarizer 210a has an S2 of about 7.21%, an S2/S1 of about 4.90, and a pass state reflectance of about 0.56%. For comparison, a comparative reflective polarizer 210c has an S2 of about 7.16%, an S2/S1 of about 59.7, and a pass state reflectance of about 1.44%. The comparative reflective polarizer 210c can be thermoformed in a conventional thermoforming process where the reflective polarizer is stretched substantially more along the second (pass) direction during thermoforming than along the first (block) direction, for example. Also, average reflectance of a plurality of layers 10, 11 of a reflective polarizer for substantially normally incident light polarized along the second direction prior to biaxially stretching is shown as open squares in FIG. 3. The average reflectance of a plurality of layers 10, 11 of a reflective polarizer for substantially normally incident light polarized along the second direction prior to and after biaxially stretching and or shaping may be denoted Rp1 and Rp2, respectively. FIG. 4A is a plot of difference in average pass state reflectances in blue and green wavelength ranges 31b and 31g (see, e.g., FIG. 2) as a function of stretch ratio S2/S1 for substantially normally incident light 20, according to some embodiments. FIG. 4B shows an expanded portion of the plot of FIG. 4A. FIG. 5A is a plot of differences in average pass state reflectance in blue and red wavelength ranges 31b and 31r (see, e.g., FIG. 2) as a function of stretch ratio S2/S1, according to some embodiments. FIG. 5B shows an expanded portion of the plot of FIG. 5A. The reflectances in these figures are for the plurality of layers 10, 11 of the reflective polarizers and for substantially normally incident light. The solid circles in these figures show example data for various S2/S1 ratios. The open squares along the ordinate show results for unstretched reflective polarizer samples. The difference in reflectance in the different wavelength ranges for the unstretched reflective polarizer samples can be selected by suitable selection of layer thicknesses and refractive index differences as would be appreciated by those of ordinary skill in the art.

In some embodiments, a (e.g., curved) reflective polarizer 200, 210 (see, e.g., FIGS. 1 and 7-9) is such that for at least one location 211 on the (e.g., curved) reflective polarizer, a substantially normally incident light 20 at the at least one location 211, a blue wavelength range extending from about 420 nm to about 480 nm, a green wavelength range extending from about 490 nm to about 560 nm, and a red wavelength range extending from about 590 nm to about 670 nm, the plurality of (e.g., curved) polymeric layers 10, 11 has average reflectances R2b, R2g and R2r in the respective blue, green and red wavelength regions when the incident light is polarized along the second direction (y-direction). In some embodiments, R2b−R2g≥0.1%, 0.15%, or 0.2%, or 0.25%, or 0.3%. In some such embodiments, or in other embodiments, R2b−R2g≤2.2%, or 2.0%, or 1.8%, or 1.6%, or 1.5%, or 1.4%. In some such embodiments, or in other embodiments, R2b−R2r≥−0.1%, or 0%, or 0.05%, or 0.1%, or 0.2%, or 0.3%. In some such embodiments, or in other embodiments, R2b−R2r≤2.5%, or 2.25%, or 2.0%, or 1.75%, or 1.6%, or 1.5%, or 1.4%. For example, in some embodiments, 2.2%≥R2b−R2g≥0.1% and 2.5%≥R2b−R2r≥−0.1%; or 2.0%≥R2b−R2g≥0.15% and 2.25%≥R2b−R2r≥0%; or 1.6%≥R2b−R2g≥0.15% and 1.75%≥R2b−R2r≥0%. In some embodiments, the plurality of layers 10, 11 of both the biaxially stretched/curved reflective polarizer and the reflective polarizer before it is biaxially stretched/curved has differences of average reflectances in the blue, green and red wavelength regions in any of these ranges. The average reflectances of the plurality of layers 10, 11 of the reflective polarizer before it is biaxially stretched/curved may be referred to as R1b, R1g and R1r in the respective blue, green and red wavelength regions.

FIG. 6 is a scatter plot of average transmittance of reflective polarizers (in air) for substantially normally incident light for a block polarization state and for various stretching conditions, according to some embodiments. It has been found, according to some embodiments, that the stretching processes described herein do not substantially increase transmittance of substantially normally incident light in a block polarization state. Average transmittance (T_block) in each of a blue wavelength range of 420 to 480 nm, a green wavelength range of 490 to 560 nm, a red wavelength range of 590 to 670, and a visible wavelength range of 420 to 680 nm are shown. Average transmittance of reflective polarizer samples before stretching are provided along the axis at S2/S1=0. In some embodiments, for the at least one location 211 on the (e.g., curved and/or biaxially stretched) reflective polarizer 200, 210, the substantially normally incident light 20 at the at least one location, and the visible wavelength range 30, the reflective polarizer has an average transmittance of less than about 1%, or 0.9%, or 0.8%, or 0.7%, or 0.6%, or 0.5%, or 0.4%, or 0.3%, or 0.25%, or 0.2%, or 0.15%, or 0.12%, or 0.1% when the incident light is polarized along the first direction (x-direction, block direction). In some embodiments, for the at least one location 211 on the (e.g., curved and/or biaxially stretched) reflective polarizer 200, 210 and for the substantially normally incident light 20 at the at least one location, the reflective polarizer has an average transmittance of less than about 1%, or 0.9%, or 0.8%, or 0.7%, or 0.6%, or 0.5%, or 0.4%, or 0.3%, or 0.25%, or 0.2%, or 0.15%, or 0.12%, or 0.1% in each of the blue, green and red wavelength regions 31b, 31g, and 31r when the incident light is polarized along the first direction.

In some embodiments, a method of biaxially stretching and/or shaping a reflective polarizer is provided. In some embodiments, a method includes providing a reflective polarizer substantially uniaxially oriented along a first direction (e.g., x-direction) and including a plurality of polymeric layers 10, 11 numbering at least 10 in total (or in a range described elsewhere herein) where each of the polymeric layers 10, 11 has an average thickness of less than about 500 nm (or in a range described elsewhere herein). A substantially uniaxially oriented reflective polarizer can include birefringent layers having a refractive index n1x in the first direction (x-direction) substantially higher than a refractive index n1y in the second direction (y-direction) which can be approximately equal to a refractive index n1z in the thickness direction. For example, the absolute value of the difference in the refractive indices in the second and thickness directions may be less than 0.02 or less than 0.01, and the difference in the refractive indices in the first and second directions may be greater than 0.05, or greater than 0.10. The refractive indices can be determined for a wavelength of 532 nm or 633 nm, for example. Substantially uniaxially oriented multilayer optical films are described in U.S. Pat. Appl. Pub. No. 2010/0254002 (Merrill et al.), for example. Suitable substantially uniaxially oriented reflective polarizers include those available from 3M Company (St. Paul, MN) under the tradename 3M Image Quality Polarizer Enhanced (IQP E). In some embodiments, for a substantially normally incident light 20, and for a visible wavelength range 30 extending from about 420 nm to about 680 nm, the plurality of polymeric layers 10, 11 of the substantially uniaxially oriented reflective polarizer has: an average reflectance of greater than about 60% (or in a range described elsewhere herein for reflective polarizer 200) when the incident light is polarized along the first direction (x-direction); and an average transmittance of greater than about 60% (or in a range described elsewhere herein for reflective polarizer 200) and an average reflectance Rp1 (see, e.g., open squares indicated in FIG. 3) when the incident light is polarized along a second direction (y-direction) orthogonal to the first direction. Rp1 can be less than about 1% or can be in any range described elsewhere herein for Rp2.

In some embodiments, the method incudes biaxially stretching the reflective polarizer along the first and second directions by respective S1 and S2 percentages, where S2≥2% (or in a range described elsewhere herein) and S2/S1≤10 (or in a range described elsewhere herein), such that for at least one location on the biaxially stretched reflective polarizer, for a substantially normally incident light 20 at the at least one location, and for the visible wavelength range, the plurality of polymeric layers 10, 11 of the biaxially stretched reflective polarizer has an average reflectance Rp2 (see, e.g., solid circles indicated in FIG. 3) of less than about 1% (or in a range described elsewhere herein) when the incident light at the at least one location is polarized along the second direction. In some embodiments, 1≤S2/S1≤5 and 12%≥S2≥4%, for example.

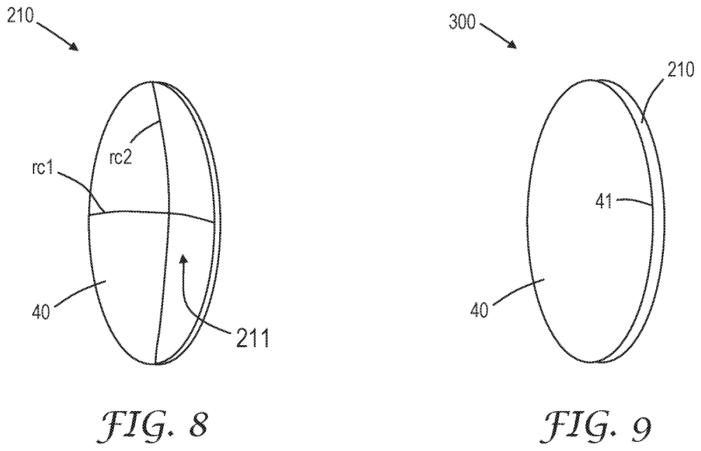

In some embodiments, the method incudes forming (e.g., thermoforming) the reflective polarizer into a curved reflective polarizer such that the curved reflective polarizer has first and second radii of curvature rc1 and rc2 (see, e.g., FIG. 8) along mutually orthogonal first and second directions where each of the first and second radii of curvature rc1 and rc2 is greater than about 1 mm and less than about 500 mm (or each of rc1 and rc2 can be in a range described elsewhere herein), such that for at least one location on the biaxially stretched reflective polarizer, for a substantially normally incident light 20 at the at least one location, and for the visible wavelength range, the plurality of polymeric layers 10, 11 of the biaxially stretched reflective polarizer has an average reflectance Rp2 (see, e.g., solid circles indicated in FIG. 3) of less than about 1% (or in a range described elsewhere herein) when the incident light at the at least one location is polarized along the second direction.

In some embodiments, the biaxially stretching and/or forming process results in substantially no, or only a modest, increase in Rp1 to Rp2. In some embodiments, Rp2 is no greater than about 3, or 2.75, or 2.5, or 2.25, or 2, or 1.75, or 1.6, or 1.5, or 1.4, or 1.3 times Rp1. In some embodiments, 1%≥Rp2≥Rp1, or 0.8%≥Rp2≥Rp1, or 0.6%≥Rp2≥Rp1.

In some embodiments, for the at least one location on the resulting curved and/or biaxially stretched reflective polarizer, the substantially normally incident light 20 at the at least one location, a blue wavelength range extending from about 420 nm to about 480 nm, a green wavelength range extending from about 490 nm to about 560 nm, and a red wavelength range extending from about 590 nm to about 670 nm, the plurality polymeric layers of the curved and/or biaxially stretched reflective polarizer has average reflectances R2b, R2g and R2r in the respective blue, green and red wavelength regions when the incident light is polarized along the second direction where 2.2%≥R2b−R2g≥0.1% and 2.5%≥R2b−R2r≥−0.1% (or these differences can be in any range described elsewhere herein). In some embodiments, the plurality of polymeric layers 10, 11 of the substantially uniaxially oriented reflective polarizer has average reflectances R1b, R1g and R1r in the respective blue, green and red wavelength regions when the incident light is polarized along the second direction, where 2.2%≥R1b−R1g≥0.1% and 2.5%≥R1b−R1r≥−0.1% (or these differences can be in any range described elsewhere herein).

In some embodiments, the biaxially stretching and/or forming is carried out at an elevated temperature. For example, the biaxially stretching and/or forming can be carried out a temperature greater than a glass transition temperature of at least one layer of the reflective polarizer. In some embodiments, the biaxially stretching and/or forming is carried out at a temperature in a range of about 100° C. to about 200, or 160, or 140° C., for example.

FIG. 7 is a schematic cross-sectional view of a curved reflective polarizer 210, according to some embodiments. The reflective polarizer 210 can correspond to reflective polarizer 200, for example. The cross-section of FIG. 7 is in an x′z-plane (orthogonal to a y′-direction). The x′-direction can correspond to either the x-direction or the y-direction, for example. The curved reflective polarizer 210 may appear similarly in each of the xz- and yz-planes (see, e.g., FIG. 8). In some embodiments, in each of first (xz-plane) and second (yz-plane) cross-sectional planes of the curved reflective polarizer 210 that are substantially parallel to a thickness direction (z-direction) of the reflective polarizer and comprise the respective first and second directions, the curved reflective polarizer has an arc length AL and a cord length CL. In some embodiments, (AL−CL)/CL (expressed as a percent) is greater than about 0.02%, or 0.03%, or 0.04%, or 0.05%, or 0.07%, or 0.1%, or 0.2%, or 0.5%, or 1%. In some such embodiments, or in other embodiments, (AL−CL)/CL (expressed as a percent) is less than about 20%, or 15%, or 12%, or 10%. In some embodiments, 0.02%≤(AL−CL)/CL×100%≤20%, or 0.05%≤(AL−CL)/CL×100%≤15%, or 0.1%≤(AL−CL)/CL×100%≤12%, or 0.5%≤(AL−CL)/CL×100%≤10%, for example.

FIG. 8 is a schematic perspective view of a curved reflective polarizer 210, according to some embodiments. In some embodiments, the curved reflective polarizer 210 has first and second radii of curvature rc1 and rc2 along mutually orthogonal first and second directions (e.g., x- and y-directions). In some embodiments, each of the first and second radii of curvature rc1 and rc2 is greater than about 1, or 2, or 3, or 4, or 5 mm. In some such embodiments, or in other embodiments, each of the first and second radii of curvature rc1 and rc2 is less than about 500, or 450, or 400, or 350, or 300, or 250, or 200, or 150, or 100 mm. In some embodiments, each of the first and second radii of curvature is in a range of about 1 mm to about 500 mm, or about 2 mm to about 400 mm, or about 3 mm to about 350 mm, or about 4 mm to about 300 mm, or about 5 mm to about 250 mm, for example.

FIG. 9 is a schematic perspective view of a lens assembly 300, according to some embodiments. In some embodiments, the lens assembly 300 includes an optical lens 40 having a curved first major surface 41; and a (e.g., curved and/or biaxially stretched) reflective polarizer 210 bonded, and substantially conforming, to the curved first major surface 41. The reflective polarizer 210 can be bonded to the major surface 41 via an optically clear adhesive layer or the reflective polarizer 210 can be bonded to the major surface 41 by virtue of the optical lens 40 being molded directly onto to reflective polarizer which can result, for example, in diffusion bonding of the optical lens to the reflective polarizer. The optical lens 40 can be a polymeric optical lens (e.g., formed from polymethyl methacrylate or cyclic olefin polymer or copolymer). In some embodiments, the lens assembly 300 is formed by thermoforming the reflective polarizer 200 into a curved reflective polarizer 210, where the thermoforming process biaxially stretches the reflective polarizer as described elsewhere herein, and then injection molding the optical lens 40 onto the curved reflective polarizer 210. Injection molding an optical lens on a curved reflective polarizer is generally described in U.S. Pat. Appl. Pub. No. 2021/0208320 (Ambur et al.), for example.

### EXAMPLES

Samples of reflective polarizer film (available from 3M Company, St. Paul, MN under the tradename IQP E) were stretched two-dimensionally at 120° C. using a laboratory film stretcher (KARO IV from Bruckner Maschinenbau Gmbh & Co. KG, Siegsdorf, Germany). A two-dimensional fiducial pattern was applied on each film sample to record elongation along block and pass directions (x- and y-directions) and were used to calculate the respective percent strains S1 and S2. In the film stretcher, the film samples were pre-heated at 120° C. for 30 seconds and then stretched into desired strain level with the stretching rate at 1% strain per second. To test the stretched film samples, each film sample to be tested was laminated on a glass substrate with a layer of optically clear adhesive, and then a layer of black tape was laminated on top of the film. The reflection spectra from the reflective polarizer samples were collected by a Lambda 1050 spectrophotometer (available from PerkinElmer, Waltham, MA). The reflection from glass, film skin layer and black tape were also measured and used to subtract surface reflections of the reflective polarizer film samples to arrive at the reflection spectra of the plurality of layers 10, 11 as well of reflection spectra of the reflective polarizer. Results are shown in FIGS. 3, 4A-4B, 5A-5B, and 6 for various values of S1 and S2.

For comparison, a reflective polarizer sample was stretched with an S1 of about 0% and an S2 of about 9%. The pass state reflectance of the plurality of layers 10, 11 for substantially normally incident light increased from about 0.15% before stretching to about 1.75% after stretching.

Terms such as “about” will be understood in the context in which they are used and described in the present description by one of ordinary skill in the art. If the use of “about” as applied to quantities expressing feature sizes, amounts, and physical properties is not otherwise clear to one of ordinary skill in the art in the context in which it is used and described in the present description, “about” will be understood to mean within 10 percent of the specified value. A quantity given as about a specified value can be precisely the specified value. For example, if it is not otherwise clear to one of ordinary skill in the art in the context in which it is used and described in the present description, a quantity having a value of about 1, means that the quantity has a value between 0.9 and 1.1, and that the value could be 1.

Terms such as “substantially” will be understood in the context in which they are used and described in the present description by one of ordinary skill in the art. If the use of “substantially” with reference to a property or characteristic is not otherwise clear to one of ordinary skill in the art in the context in which it is used and described in the present description and when it would be clear to one of ordinary skill in the art what is meant by an opposite of that property or characteristic, the term “substantially” will be understood to mean that the property or characteristic is exhibited to a greater extent than the opposite of that property or characteristic is exhibited.

All references, patents, and patent applications referenced in the foregoing are hereby incorporated herein by reference in their entirety in a consistent manner. In the event of inconsistencies or contradictions between portions of the incorporated references and this application, the information in the preceding description shall control.

Descriptions for elements in figures should be understood to apply equally to corresponding elements in other figures, unless indicated otherwise. Although specific embodiments have been illustrated and described herein, it will be appreciated by those of ordinary skill in the art that a variety of alternate and/or equivalent implementations can be substituted for the specific embodiments shown and described without departing from the scope of the present disclosure. This application is intended to cover any adaptations, or variations, or combinations of the specific embodiments discussed herein. Therefore, it is intended that this disclosure be limited only by the claims and the equivalents thereof.

1. A biaxially stretched reflective polarizer comprising a plurality of biaxially stretched polymeric layers numbering at least 10 in total, each of the biaxially stretched polymeric layers having an average thickness of less than about 500 nm, the biaxially stretched reflective polarizer stretched along in-plane mutually orthogonal first and second directions by respective S1 and S2 percentages, S2≥2%, S2/S1≤10, such that for at least one location on the biaxially stretched reflective polarizer, a substantially normally incident light at the at least one location, and a visible wavelength range extending from about 420 nm to about 680 nm, the plurality of biaxially stretched polymeric layers has:
an average reflectance of greater than about 60% when the incident light is polarized along the first direction; and
an average transmittance of greater than about 60% and an average reflectance of less than about 1% when the incident light is polarized along the second direction.

2. The biaxially stretched reflective polarizer of claim 1, wherein an incident angle of the substantially normally incident light is less than about 10 degrees.

3. The biaxially stretched reflective polarizer of claim 1, wherein S2/S1≥0.5.

4. The biaxially stretched reflective polarizer of claim 1, wherein 1≤S2/S1≤5.

5. The biaxially stretched reflective polarizer of claim 1, wherein 12%≥S2≥4%.

6. A lens assembly comprising:
an optical lens comprising a curved first major surface; and
the biaxially stretched reflective polarizer of claim 1 bonded, and substantially conforming, to the curved first major surface.

7. A curved reflective polarizer comprising a plurality of curved polymeric layers numbering at least 10 in total, each of the curved polymeric layers having an average thickness of less than about 500 nm, the curved reflective polarizer having first and second radii of curvature along mutually orthogonal first and second directions, each of the first and second radii of curvature greater than about 1 mm and less than about 500 mm, such that for at least one location on the curved reflective polarizer, a substantially normally incident light at the at least one location, and a visible wavelength range extending from about 420 nm to about 680 nm, the plurality of curved polymeric layers has:
an average reflectance of greater than about 60% when the incident light is polarized along the first direction; and
an average transmittance of greater than about 60% and an average reflectance of less than about 1% when the incident light is polarized along the second direction.

8. The curved reflective polarizer of claim 7, wherein in each of first and second cross-sectional planes of the curved reflective polarizer that are substantially parallel to a thickness direction of the reflective polarizer and comprise the respective first and second directions, the curved reflective polarizer has an arc length AL and a cord length CL, and wherein (AL−CL)/CL is greater than about 0.02% and less than about 20%.

9-15. (canceled)

16. A lens assembly comprising:
an optical lens comprising a curved first major surface; and
the curved reflective polarizer of claim 7 bonded, and substantially conforming, to the curved first major surface.

17. A curved reflective polarizer comprising a plurality of curved polymeric layers numbering at least 10 in total, each of the curved polymeric layers having an average thickness of less than about 500 nm, the curved reflective polarizer having first and second radii of curvature along mutually orthogonal first and second directions, each of the first and second radii of curvature greater than about 1 mm and less than about 500 mm, such that for at least one location on the curved reflective polarizer, a substantially normally incident light at the at least one location, a blue wavelength range extending from about 420 nm to about 480 nm, a green wavelength range extending from about 490 nm to about 560 nm, and a red wavelength range extending from about 590 nm to about 670 nm, the plurality of curved polymeric layers has average reflectances R2b, R2g and R2r in the respective blue, green and red wavelength regions when the incident light is polarized along the second direction, 2.2%≥R2b−R2g≥0.1%, 2.5%≥R2b−R2r≥−0.1%.

18. The curved reflective polarizer of claim 17, wherein for the substantially normally incident light at the at least one location, and for a visible wavelength range extending from about 420 nm to about 680 nm, the plurality of curved polymeric layers has:
an average reflectance of greater than about 60% when the incident light is polarized along the first direction; and
an average transmittance of greater than about 60% and an average reflectance of less than about 1% when the incident light is polarized along the second direction.

19. A lens assembly comprising:
an optical lens comprising a curved first major surface; and
the curved reflective polarizer of claim 17 bonded, and substantially conforming, to the curved first major surface.
